(19) United States
(12) Patent Application Publication
(10) Pub. No.: US 2017/0193539 A1
(43) Pub. Date: Jul. 6, 2017

(54) TIME-VALUE ESTIMATION METHOD AND SYSTEM FOR SHARING ENVIRONMENT

(71) Applicant: TCL RESEARCH AMERICA INC., San Jose, CA (US)

(72) Inventors: MENGWEN LIU, San Jose, CA (US); LIFAN GUO, San Jose, CA (US); HAOHONG WANG, San Jose, CA (US)

(73) Assignee: TCL RESEARCH AMERICA INC.

(21) Appl. No.: 14/984,812

(22) Filed: Dec. 30, 2015

(51) Int. Cl. G06Q 30/02; G06Q 30/06; H04L 29/08

(52) U.S. Cl. CPC G06Q 30/0206; H04L 67/10; G06Q 30/0645

(57) ABSTRACT

The present disclosure provides a time-value estimation method for sharing environment, including obtaining time-values of a plurality of shared items from a sharing platform. A time-value is a time duration for the shared item to be shared or traded. Further, a plurality of features of the plurality of shared items from the sharing platform may be extracted. The features may include objective-level features related to a specific item and subjective-level features related to an owner of the specific item. A time-value model may be trained to obtain a time-value estimation function based on the time-values of the plurality of shared items and the plurality of features of the plurality of shared items. The method may further include estimating a time-value of an item in the sharing platform based on the plurality of features of the item and the time-value estimation function.

### FIELD OF THE DISCLOSURE

The present disclosure relates to the field of information technologies and, more particularly, relates to a time-value estimation method and system for sharing environment.

### BACKGROUND

In the environment of sharing economy, a number of peer-to-peer platforms provide venues for individuals who share products or provide services, such as peer-to-peer accommodation (e.g., Airbnb), car sharing (e.g., Zipcar), Customer-to-Customer (C2C) E-commerce (e.g., eBay), etc. Products or services, which are traditionally provided by long-established industries, can be shared or obtained from individuals. Through sharing assets, a sharing economy or a sharing platform has many advantages including lower costs, smaller impact on environment, higher self-reliance, etc.

The purchase decision of a product or service in a sharing economy is quite different from that of a regular product in traditional marketplace. Unlike a regular product whose value is often quantified by its price, the value of a “shareable” item cannot be measured simply using the price. Some C2C platforms utilize non-price factors to measure the “goodness” of products, such as conversation rate, click-through-rate (CTR), number of user clicks, etc.

However, existing sharing platforms fail to take time factor into consideration. High conversation rate or CTR cannot guarantee a product to be traded quickly. Low transaction rate may consequently decrease the cash flow of a sharing economy.

The disclosed method and system are directed to solve one or more problems set forth above and other problems.

### BRIEF SUMMARY OF THE DISCLOSURE

One aspect of the present disclosure provides a time-value estimation method for sharing environment, including obtaining time-values of a plurality of shared items from a sharing platform. A time-value is a time duration for the shared item to be shared or traded. Further, a plurality of features of the plurality of shared items from the sharing platform may be extracted. The features may include objective-level features related to a specific item and subjective-level features related to an owner of the specific item. A time-value model may be trained to obtain a time-value estimation function based on the time-values of the plurality of shared items and the plurality of features of the plurality of shared items. The method may further include estimating a time-value of an item in the sharing platform based on the plurality of features of the item and the time-value estimation function.

Another aspect of the present disclosure provides a time-value estimation system for sharing environment, including: an information acquisition module, a feature extraction module, a time-value model generation module, and a time-value estimation module. The information acquisition module may be configured to obtain time-values of a plurality of shared items and related information of the plurality of shared items from a sharing platform, where a time-value is a time duration for the shared item to be shared or traded. The feature extraction module may be configured to extract a plurality of features of the plurality of shared items from the related information of the plurality of shared items. The features include objective-level features related to a specific item and subjective-level features related to an owner of the specific item. The time-value model generation module may be configured to obtain a time-value estimation function based on the time-values of the plurality of shared items and the plurality of features of the plurality of shared items. Further, the time-value estimation module may be configured to estimate a time-value of an item in the sharing platform based on the plurality of features of the item and the time-value estimation function from the time-value model generation module.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary environment incorporating certain embodiments of the present invention;

FIG. 2 illustrates an exemplary computing system consistent with the disclosed embodiments;

FIG. 3 illustrates an exemplary time-value estimation system for sharing environment consistent with the disclosed embodiments;

FIG. 4 illustrates an exemplary time-value estimation process for sharing environment consistent with the disclosed embodiments;

FIG. 5 illustrates an exemplary time-value estimation process for a buyer consistent with the disclosed embodiments; and

FIG. 6 illustrates an exemplary time-value estimation process for a seller consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

FIG. 1 illustrates an exemplary environment 100 incorporating certain disclosed embodiments. As shown in FIG. 1, environment 100 may include a terminal 102, a server 106, a user 108 and a network 110. Certain device(s) may be omitted and other devices may be added. A user 108 may operate terminal 102 for certain services provided by server 106. Although only one server 106 and one terminal 102 is shown in the environment 100, any number of terminals 102 or servers 106 may be included, and other devices may also be included.

Terminal 102 may refer to any appropriate user terminal with certain computing capabilities, such as a personal computer, a hand-held computing device (tablet), a smart phone or mobile phone, or any other user-side computing device. Terminal 102 may be implemented on any appropriate computing platform. Terminal 102 may be used by user 108 to connect to network 110 and make requests to server 106 via a webpage, an app or other interfaces. For example, user 108 may use terminal 108 to visit a website hosted by server 106 for sharing and trading activities, such as renting a room, selling a used item, etc.

Server 106 may refer to one or more server computers configured to provide certain server functionalities (e.g., hosting a website, conducting a search, processing data), such as data query and computation tasks. Server 106 may include one or more processors to execute computer programs in parallel. Server 106 may store data (e.g., item descriptions) to be accessed by terminals 102. For example, server 106 may host an app and/or a website to facilitate sharing and trading activities between users 108, such as providing an interface for a seller to post an item, an interface for a buyer to search and browse items, a mechanism for buyers and sellers to communicate, a mechanism to complete buying or selling transactions, etc.

Although server 106 is shown in a single computer configuration, more computers or server clusters can be included in server 106. Server 106 may provide cloud-based services in a cloud computing environment, i.e., the use of computing resources (hardware and software) that are delivered as a service over a network infrastructure (e.g., the Internet). The cloud computing environment may include any private cloud configuration and/or public cloud configuration. Various servers 106 (i.e., server services) in the cloud may be configured to provide data storage and computation functionalities (e.g., training and utilizing a time-value model).

Terminal 102 and server 106 may communicate with each other through communication network 110, such as the Internet or other types of computer networks or telecommunication networks, either wired or wireless, such as a cable network, a phone network, and/or a satellite network, etc.

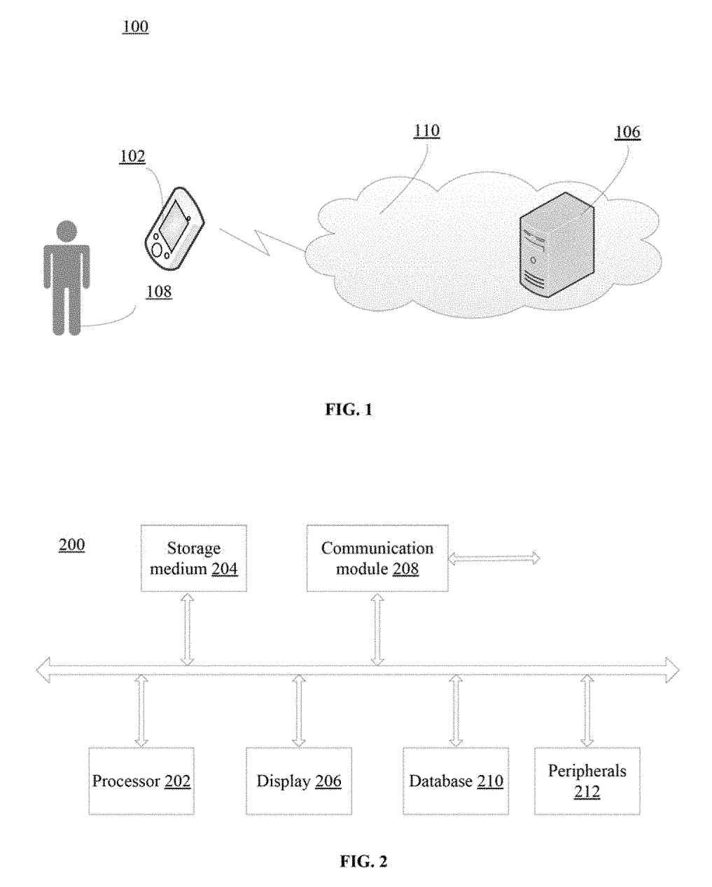

Terminal 102 and/or server 106 may be implemented on any appropriate computing circuitry platform. FIG. 2 shows a block diagram of an exemplary computing system 200 capable of implementing terminal 102 and/or server 106.

As shown in FIG. 2, computer system 200 may include a processor 202, a storage medium 204, a display 206, a communication module 208, a database 210, and peripherals 212. Certain devices may be omitted and other devices may be included.

Processor 202 may include any appropriate processor or processors. Further, processor 202 can include multiple cores for multi-thread or parallel processing. Processor 202 may execute sequences of computer program instructions to perform various processes, such as an information processing program. Storage medium 204 may include memory modules, such as ROM, RAM, flash memory modules, and erasable and rewritable memory, and mass storages, such as CD-ROM, U-disk, and hard disk, etc. Storage medium 204 may store computer programs for implementing various processes, when executed by processor 202.

Further, communication module 208 may include network devices for establishing connections through the network 110. Database 210 may include one or more databases for storing certain data (e.g., descriptions of shared or traded items) and for performing certain operations on the stored data, such as database searching and data retrieving.

Display 206 may include any appropriate type of computer display device or electronic device display (e.g., CRT or LCD based devices, touch screens). Peripherals 212 may include various sensors and other I/O devices, such as camera, motion sensors, position sensors, keyboard, mouse, etc.

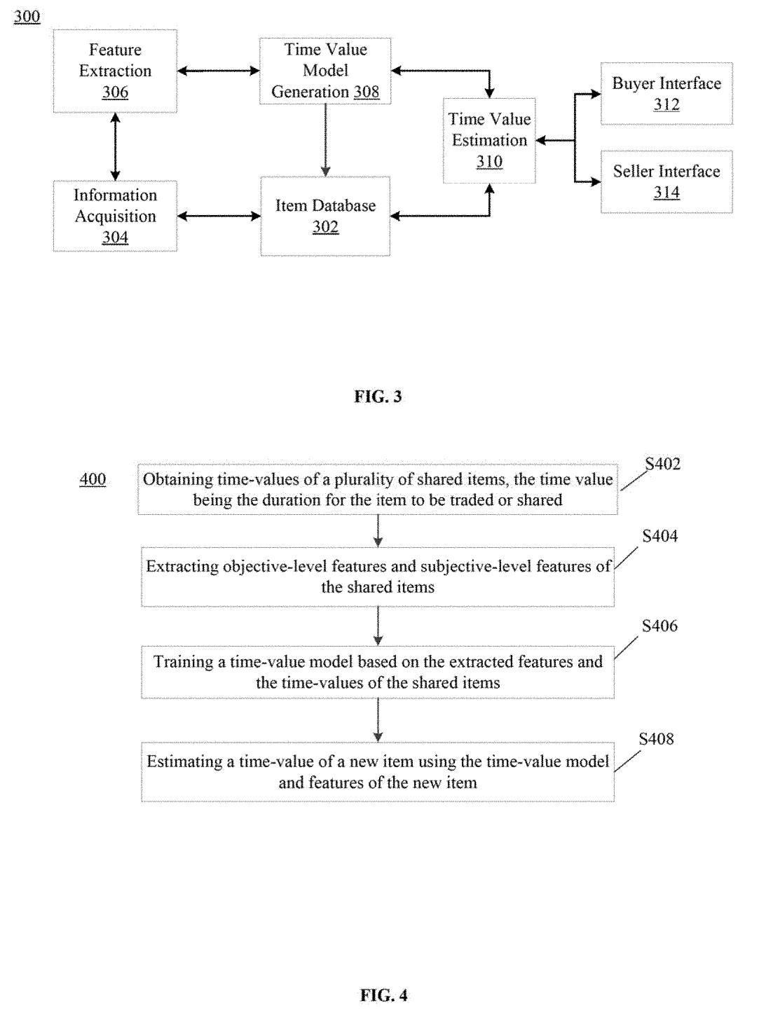

In operation, terminal 102 and/or server 106 may generate and utilize a time-value model for items on a sharing platform. FIG. 3 illustrates an exemplary time-value estimation system for sharing environment consistent with the disclosed embodiments.

Sharing environment, as used herein, may refer to any sharing platform that acts as a third party and facilitates electronic trading or sharing of products and/or services between various entities. The entities may be individuals, small businesses or other economic entities. The sharing platform may provide a website or an app for users to search, compare, post, communicate, and conduct transactions. For example, the sharing platform may be configured to facilitate peer-to-peer accommodation, car/bike sharing, Customer-to-Customer (C2C) E-commerce, etc. The sharing platform may store and present various types of information about sharable items and shared items. In an exemplary embodiment, the time-value estimation system 300 may be implemented in the sharing environment.

As shown in FIG. 3, the exemplary system 300 may include an item database 302, an information acquisition module 304, a feature extraction module 306, a time-value model generation module 308, a time-value estimation module 310, a buyer interface 312, and a seller interface 314. Certain components may be omitted and other components may be included.

The item database 302 may be configured to store related information about a plurality of sharable items and shared items. A sharable item, as used herein, may refer to an object that is currently being shared, or is going to be shared on a sharing platform. A shared item, as used herein, may refer to an object that has been shared or traded on the sharing platform. A sharable item and a shared item may be any product or service that the sharing platform supports, such as a room for rent, a used product, a ticket, a massage service, a carpool request, etc.

The related information of a sharable item or a shared item may include item description, price information, owner information and popularity information, etc. The item description may include characteristics of the item, such as condition, location, size, etc. The price information may include listed price and previous price fluctuations. The owner information may include owner profile information and owner rating. The popularity information may include, for example, conversation rate, click-through-rate, number of user clicks, comments, etc.

Further, a shared item may be associated with a time-value. Time-value, as used herein, may refer to a time duration for an item to be shared or traded. The time duration may be represented by minutes, hours, or days, and may be counted from the time when the item was posted until the time when the item was traded. When the item has been shared or traded multiple times. The time-value may be an average time duration for the item to be shared. The time-value is a time-aware metric to quantify the value of an item in sharing environment. For example, in the housing market, higher price does not mean higher value. Provided with a list of houses, it is difficult for users to distinguish properties with higher value, due to unique characteristics of each house such as house model, built year, floor size, location, etc. A house that took less days to get booked may indicate a higher value in renter perspective.

The information acquisition module 304 may be configured to obtain the related information of the shared items from the item database 302, and send the related information of the shared items to the feature extraction module 306. The feature extraction module 306 may be configured to extract features of the shared items based on the related information.

The features used for representing items in the sharing environment may be categorized into two groups: objective-level features and subjective-level features. The objective-level may be directly related to the specific shareable or shared items, while the subjective-level features may be related to owners who publish the shareable or shared items.

The objective-level features may be different in different domains (i.e., item categories). For example, in the domain of peer-to-peer accommodation, the objective-level features may include property type, number of bedrooms, number of bathrooms, amenities, price, etc. In the domain of peer-to-peer car sharing, the objective-level features may include car type, model, make, year, transmission, fuel consumption, price, etc. In the domain of Customer-to-Customer product transactions, the objective-level features may include product specifications, condition, price, etc.

Different from purchasing goods or services from conventional suppliers, the trustworthiness of items as well as people who provide those items may not be guaranteed in a sharing economy. For example, the peer-to-peer accommodation or car sharing markets may make people prone to prioritize cheap fares and low costs rather than personal relationships. Thus, the subjective-level features may be applied to measure the trustworthiness of the owner of an item. The subjective-level features may be dependent on individual owners who publish their items. The subjective-level features may include the length of content describing the item, the sentiment expressed in the content, the number of images, the credibility of the owner, etc. In some embodiments, the more information an owner is willing to disclose, the more credible the owner is. Further, the information asymmetry caused by lemon market may be mitigated. That is, when features associated with the owner are incorporated to train the time-value model, the time-value of an item may indicate credibility and reliability of the owner, so that the buyer may make a more informed choice and avoid choosing lemon products.

The time-value model generation module 308 may be configured to train a time-value model based on the extracted features of the shared items and the time-values of the shared items. In the training process, based on extracted feature values of the shared items and time-values of the shared items, model parameters of an estimation function may be trained. In some embodiments, a Poisson Regression model may be applied to generate the time-value model.

The generated time-value model may be used in various applications. The time-value estimation module 310 may be configured to extract features of a sharable item, and estimate a time-value of a sharable item based on the generated time-value model and the extracted features. When the time-value model is generated, given a new item, a time-value of the new item may be estimated or predicted by applying feature values of the new item to the estimated function.

The buyer interface 312 may be configured to facilitate an item search and display searched items in an ordered sequence based on the time-value estimations. When a user submits a search query with specific requirements through the buyer interface 312, the buyer interface 312 may be configured to obtain a list of items from the item database 302 that satisfies the specific requirements. The buyer interface 312 may be further configured to obtain time-values of the searched items from the time estimation module 310, and display the searched items in a sequence ordered based on the time-values of the searched items.

The seller interface 314 may be configured to allow a user to draft a posting of a to-be-posted item, display an estimated time-value of the to-be-posted item based on the drafted posting, allow the user to revise the drafted posting, and publish the to-be-posted item. The seller interface 314 may be configured to send the drafted posting of the to-be-posted item to the time-value estimation module 310, and receive the estimated value of the to-be-posted item from the time-value estimation module 310. In some embodiments, the seller interface 314 may be further configured to provide revise suggestion to improve the estimated time-value, such as adding more photos or adjusting the price. The revise suggestions may be offered to the seller free of charge or with charges.

In operation, the information acquisition module 304 may retrieve time-values of shared items and related information of the shared items from the item database 302. The related information of the shared item may include item description, price information, owner information, and popularity information. The feature extraction module 306 may extract features of the shared item based on the related information. The time-value model generation module 308 may generate an estimate function based on the extracted features and the time-values of the shared items. The estimate function may predict a time-value of an item based on extracted features and model parameters.

Further, the generated time-value model may be used in the time-value estimation module 310 to provide time-value estimations for the buyer interface 312 and the seller interface 314. A buyer may submit a search query through the buyer interface 312 and obtain a list of searched items ordered based on the estimated time-values. A seller may draft an item posting through the seller interface 314, check the estimated time-value of the drafted item, and revise the item posting until a satisfied time-value is obtained.

The item database 302 and the time-value estimation module 310 may be implemented on the sharing platform, for example, on server 106. The information acquisition module 304, the feature extraction module 306, and the time-value model generation module 308 may be implemented on server 106 or terminal 102. For example, the information acquisition module 304, the feature extraction module 306, and the time-value model generation module 308 may be imbedded in the sharing platform to generate the time-value model. In another example, the information acquisition module 304, the feature extraction module 306, and the time-value model generation module 308 may be a stand-alone system configured on a separate device to generate the time-value model based on data transmitted from the sharing platform (e.g., the item database 302). Further, the time-value estimation module 310, the buyer interface 312, and the seller interface 314 may be implemented on terminal 102. Users (e.g., buyers and sellers) may operate terminal 102 to access the sharing platform and perform various operations (e.g., search, browse, share an item).

The present disclosure provides a time-value estimation method for sharing environment. FIG. 4 illustrates an exemplary time-value model generation process for sharing environment consistent with the disclosed embodiments. The time-value (TV) model may be used to, when given an item in a sharing platform, predict the time-value of the item.

As shown in FIG. 4, time-values of a plurality of shared items may be obtained from a sharing platform or an item database (S402). In some embodiments, time-values of a plurality of shared items may be obtained from two or more sharing platforms in a same category. The item may be, for example, a house, a car, a pre-owned product, etc. Accordingly, the sharing platform may be a platform for trading or sharing houses, cars, second hand products, etc. The time-value of the item may refer to a time duration for the item to be shared or traded, such as the number of days or hours taken for the item to be shared or traded.

Multiple features may be extracted from related information of the shared items (S404). The features may be used for representing the shared items in the sharing platform, and may be categorized into two groups: objective-level features and subjective-level features. The related information of the shared items may be obtained from the sharing platform or the item database, and may include item description, price information, owner information, and popularity information.

The objective-level features may be different in different domains (i.e., item categories). For example, in the domain of peer-to-peer accommodation, the objective-level features may include property type, number of bedrooms, number of bathrooms, amenities, price, etc. In the domain of peer-to-peer car sharing, the objective-level features may include car type, model, make, year, transmission, fuel consumption, price, etc. In the domain of Customer-to-Customer product transactions, the objective-level features may include product specifications, condition, price, etc. In some embodiments, the subjective-level features may further include popularity information of the shared item, such as conversation rate, click-through-rate, number of user clicks, etc.

The subjective-level features may be applied to measure the trustworthiness of the owner of an item. The subjective-level features may be dependent on individual owners who publish their items. The subjective-level features may include the length of content describing a shareable item, the sentiment expressed in the content, the number of images, the credibility of the owner, the rating of the owner, comments from previous buyers, etc.

In some embodiments, the more information an owner is willing to disclose, the more credible the owner is. In some embodiments, natural language processing techniques may be applied to extract information from the sentiment expressed in owner description or buyer comments and obtain feature values. For example, positive word occurring frequency in a buyer comment may be extracted as a subjective-level feature. In another example, positive word occurring frequency of one item over an averaged positive word occurring frequency of all items posted by a same owner be extracted as a subjective-level feature to indicate confidence of the owner on the specific item.

Further, a time-value model may be trained according to the extracted features and the time-values of the shared items (S406). Specifically, X may denote the item space. A dataset may contain N sets of data points: {x⁽ⁱ⁾, y⁽ⁱ⁾}ᵢ₌₁^{N}, where x⁽ⁱ⁾ ∈ X is the i^{th} item, and y⁽ⁱ⁾ denotes the time-value of the i^{th} item. Each item may be represented by n features, and may be denoted by x⁽ⁱ⁾=[x₁⁽ⁱ⁾, . . . , xₙ⁽ⁱ⁾]^{T}. In some embodiments, a bias term x⁽ⁱ⁾=1 may be included in the feature set, and the i^{th} item may be denoted as x⁽ⁱ⁾=[x₀⁽ⁱ⁾, x₁⁽ⁱ⁾, . . . , xₙ⁽ⁱ⁾]^{T}. The TV model may be applied to predict the time-value of an unseen item by learning an estimation function ƒ(x) that assigns a score (i.e., the estimated time-value) to the item.

The time-value (e.g., the number of days, hours or minutes taken for an item to be shared or traded) is a non-negative integer value. In some embodiments, a Poisson Regression model may be applied to estimate the time-value. The estimation function may be written as: ƒ(x; θ)=exp(θ^{T}x), where θ ∈ Rⁿ are model parameters. The parameters θ may be obtained from minimizing a squared loss function L(θ)=Σᵢ₌₁^{N}(y⁽ⁱ⁾(θ^{T}x⁽ⁱ⁾)−exp(θ^{T}x⁽ⁱ⁾)). Gradient descent method may be used to solve the optimization problem. The optimal value denoted as θ* may be obtained as trained model parameters.

Further, the trained time-value model may be applied to predict time-values for unseen items (S408). Specifically, a new item z may be represented by the n features extracted from as z=[z₀, z₁, . . . , zₙ]^{T}. The time-value of the new item may be obtained based on the extracted features and the trained value model. Specifically, the estimation function for the new item may be written as ƒ(z; θ*)=exp(θ*^{T}z). Thus, the time-value of the new item z may be obtained by calculating the estimation function.

Further, the time-value model may be periodically updated according to newly shared or traded items on the sharing platform. In some embodiments, the item space may be expanded to include the newly shared items. The updated time-value model may be trained based on all items in the item space. In some embodiments, the number of items for training the time-value model may be controlled. For example, items that are older than a preset time threshold may not be included in the item space for training. In some embodiments, some items may have been booked multiple times, the averaged time-values of these item may be updated. Accordingly, the time-value model may be updated based on the updated time-values.

In some embodiments, the time-value model may be updated according to one or more new features extracted from item information. That is, the feature vector representing an item may have higher dimensions. Accordingly, the time-value model may be trained based on updated feature set to obtain corresponding model parameters. The new features may be obtained when, for example, a new data mining technique is applied to extract certain characteristics from the item information.

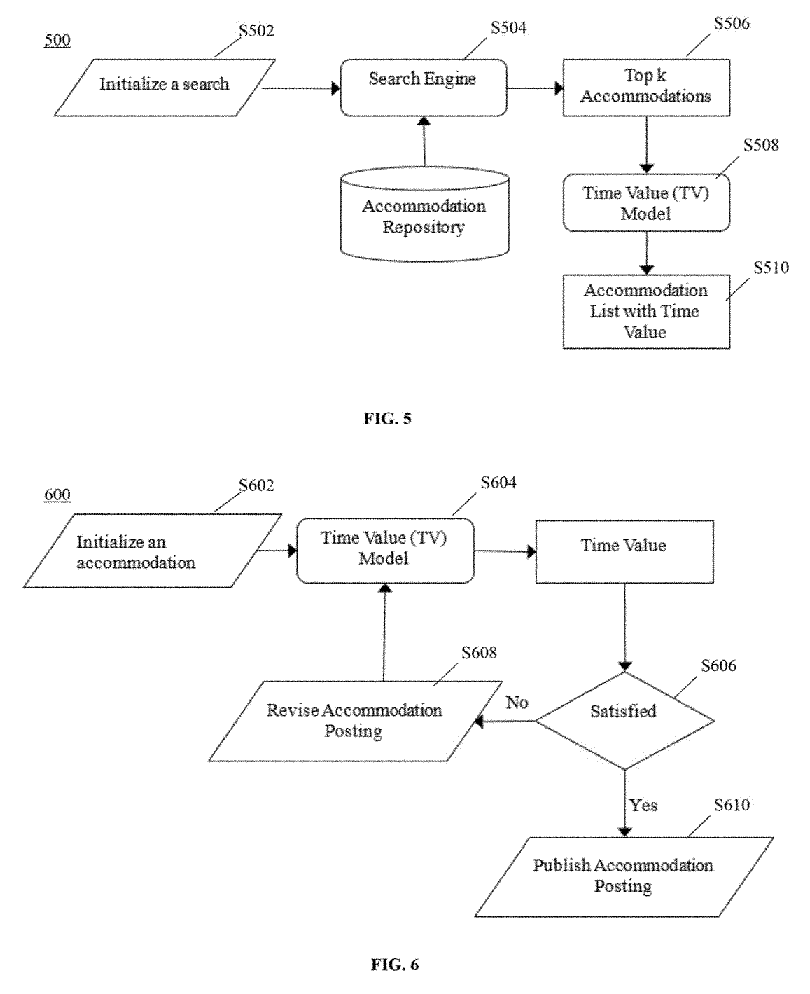

The time-value model may be used for both parties who participate in the sharing environment: buyers and sellers. A seller, as used herein, may refer to an entity that shares an item in the sharing environment. A buyer, as used herein, may refer to an entity that receives an item in the sharing environment. FIG. 5 illustrates an exemplary time-value estimation process 500 for a buyer consistent with the disclosed embodiments. The process 500 takes a peer-to-peer accommodation sharing environment as an example, which may be implemented by the time-value estimation system 300.

The peer-to-peer accommodation sharing environment may support search by queries. As shown in FIG. 5, a buyer may submit a user query to search an accommodation that satisfies his/her need (S502). The process 500 may be triggered by the user query denoted as q. The user query q may be represented as a sequence of words (e.g., houses near San Francisco) or a query condition (e.g., location=San Francisco).

A search engine (e.g., implemented by the buyer interface 312 and the item database 302) may respond to the use query and return a list of top k properties based on the relevance to the user query. The Search Engine may support both structured and unstructured query search. For a structured query search (e.g., location=San Francisco), a Boolean retrieval model may be used to retrieve items that satisfy the query condition. For an unstructured search query, a query-likelihood model may be used to retrieve relevant items. Provided with an accommodation repository A, where descriptions of accommodation A is denoted as d_{A}, the model calculates a score with respect to each accommodation a ∈ A along with the query q. The score is calculated by

$$score ( q , a ) = {\prod }_{w ∈ q} λ {p}_{MLE} ( w \vert {d}_{a} ) + ( 1 - λ ) {p}_{MLE} ( w \vert {d}_{A} )$$

Further

$${p}_{MLE} ( w \vert a ) = \frac{count ( w , {d}_{a} )}{\vert {d}_{a} \vert} , and {p}_{MLE} ( w \vert A ) = \frac{count ( w , {d}_{A} )}{\vert {d}_{a} \vert} ,$$

where count(•) denotes the number of times word w occurred in the description of a. λ is a smoothing parameter. A threshold k may be used to retain the top k accommodations according to the scores (S506). Thus, a list of houses or apartments satisfying the user query (e.g., at a specified location with specified conditions) may be obtained.

Further, a trained TV model may be applied to predict the time-value for each item in the accommodation list containing the top k properties (S508). That is, features may be extracted from each item of the top k properties and apply to the estimation function in the trained time-value model. Thus, time-values of the properties may be obtained from the trained time-value model. Based on the obtained time-values, the top k properties may be re-ranked. In some embodiments, users may be given the option to decide a ranking weight of time-values in the outputted search result.

The accommodation list containing the re-ranked top k properties may be outputted (S510). In some embodiments, the user may choose to display the accommodations from high time-values to low time-values. In some embodiments, the time-values may be displayed as a suggesting metric along with item descriptions.

FIG. 6 illustrates an exemplary time-value estimation process for a seller consistent with the disclosed embodiments. The process 600 takes a peer-to-peer accommodation sharing environment as an example, which may be implemented by the time-value estimation system 300.

The process 600 may be performed for a seller who is willing to publish a post about his property on a peer-to-peer accommodation platform. The seller may start with filling out a posting template (S602), for example, through the seller interface 314.

When the seller completes a draft posting on the seller interface 314, a trained TV model may be applied to obtain the time-value of the to-be-posted property based on extracted features from the posting, which may be a predicted number of days for the property to be booked by a customer (S604). For example, the estimated time-value of the to-be-posted item based on the draft posting may be displayed on the seller interface 314.

The seller may decide whether he/she is satisfied with the predicted time-value. Specifically, the seller interface 314 may provide the seller with two options: publish the draft posting and revise the draft posting (S606). In some embodiments, the system 300 may make one or more suggestions to the seller for improving the time-value (i.e., decreasing the predicted number of days). These suggestions may be presented on the seller interface 314 with additional charges or free of charge.

When the seller is satisfied with the time-value, the accommodation posting may be published on the sharing platform based on the choice of the seller (S610). When the seller is not satisfied with the time-value, the seller may choose to revise the accommodation posting (S608). For example, the seller may be given the opportunity to change the price, revise the post content, add more photos, etc. Further, an estimated time-value based on the revised posting may be presented to the seller (S604). The seller may repeat reviewing the estimated time-value (S604) and revising the post (S608) several rounds before he publishes the accommodation posting (S610).

The usages of the Time-value (TV) model described in the domain of peer-to-peer accommodation platforms may be easily extended to other domains of sharing economy. In one embodiment, in the domain of peer-to-peer car sharing, the process for both buyers and sellers are similar to the previously described process 500 and process 600. The TV model may be trained and obtained based on a number of car sharing records. The record document of each car may include a time duration for the car to be booked, which may be used as the time-value. The record document of each car may further include basic information (e.g., car model, make, year, transmission, price) and owner information, which may be used for feature representation and feature extraction.

In another embodiment, in the domain of Customer-to-Customer (C2C) E-commerce platforms, the information of products that have been traded on those platforms and the information of their owners may be used to train the TV model. The procedures of purchasing and selling a product are also similar to that of searching and publishing an accommodation as shown in FIGS. 5 and 6.

By using the disclosed methods and systems, a time-value estimation model may be obtained by incorporating item-specific and non-item specific features of shared items, which may be used to predict values for unseen shareable items. The TV model may be used from both buyer and seller's perspectives in the domain of peer-to-peer accommodation system. Further, the TV model may be extended to several other domains of sharing economy.

The disclosed time-value estimation method and system provides a time-aware approach to help increase transaction rate of a sharing economy. Such approach may be implemented to help peer-to-peer platforms to increase revenues by providing an environment for efficient transactions.

The disclosed time-value estimation method and system introduces the concept of time-value which quantifies the value of a product or service in the environment of a sharing economy by time-value, and provides a model to estimate the time-value of a sharable item. The time-value may be defined as how many days/hours/minutes taken for a product or service to be shared or purchased, to measure the “goodness” of a shareable item. The disclosed time-value model incorporates comprehensive features of products or services published on a peer-to-peer platform, including both objective (i.e., the basic information that is directly related to an item) and subjective-level (i.e., the information that is related to the trust of the owner of an item) features.

The benefits of the disclosed time-value estimation method and system may be two fold. When a buyer is browsing or searching for a product or service that satisfies his/her need, a product or service that has high time-value may be more likely to attract a buyer's attention. When a seller is willing to trade or share his/her products or services, the time-value may be used as a guide for publishing his/her products or services (e.g., price setting).

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A time-value estimation method for sharing environment, comprising:
obtaining time-values of a plurality of shared items from a sharing platform, wherein a time-value is a time duration for the shared item to be shared or traded;
extracting a plurality of features of the plurality of shared items from the sharing platform, wherein the features include objective-level features related to a specific item and subjective-level features related to an owner of the specific item;
training a time-value model to obtain a time-value estimation function based on the time-values of the plurality of shared items and the plurality of features of the plurality of shared items; and
estimating a time-value of an item in the sharing platform based on the plurality of features of the item and the time-value estimation function.

2. The method according to claim 1, further comprising:
receiving a search query for obtaining a list of items on the sharing platform;
returning a plurality of items satisfying conditions specified in the search query;
estimating time-values of the plurality of the returned items based on the time-value estimation function and the plurality of features of the returned items; and
displaying the plurality of the returned items in a sequence ordered based on the estimated time-values of the plurality of the returned items.

3. The method according to claim 1, further comprising:
receiving a draft post of a to-be-shared item from a seller,
estimating a time-value of the to-be-shared item based on the time-value estimation function and the plurality of features of the to-be-shared item; and
presenting the estimated time-value of the to-be-shared item to the seller.

4. The method according to claim 3, further comprising:
when presenting the estimated time-value of the to-be-shared item, providing two options to the user including publishing the draft post and revising the draft post;
when the seller selects to publish the draft post, publishing the draft post of the to-be-shared item on the sharing platform; and
when the seller selects to revise the draft post and submits a revised draft post, estimating a time-value of the to-be-shared item based on the revised draft post, and presenting the estimated time-value of the to-be-shared item to the seller.

5. The method according to claim 3, further comprising:
providing revise suggestions to improve the estimated time-value of the to-be-shared item.

6. The method according to claim 1, wherein:
the subjective-level features of an item include at least one of: length of an item description, sentiment expressed in the item description, number of images, rating of the owner, and comments from previous buyers.

7. The method according to claim 1, wherein:
when the sharing platform is in a peer-to-peer accommodation domain, the objective-level features of an item include at least one of property type, number of bedrooms, number of bathrooms, amenities, and price;
when the sharing platform is in a peer-to-peer car sharing domain, the objective-level features of an item include at least one of car type, model, make, year, transmission, fuel consumption, and price; and
when the sharing platform is in a customer-to-customer transaction domain, the objective-level features of an item include at least one of product specifications, condition, and price:

8. The method according to claim 1, wherein:
provided that N shared items are denoted as {x⁽ⁱ⁾, y⁽ⁱ⁾}ᵢ₌₁^{N}, x⁽ⁱ⁾ denotes an i^{th} item represented by the plurality of features, y⁽ⁱ⁾ denotes the time-value of the i^{th} item, θ ∈ Rⁿ are model parameters,
the time-value estimation function is denoted as ƒ(x; θ)=exp(θ^{T}x); and
trained model parameters θ* are obtained by minimizing a squared loss function L(θ)=Σᵢ₌₁^{N}(y⁽ⁱ⁾(θ^{T}x⁽ⁱ⁾)−exp(θ^{T}x⁽ⁱ⁾)).

9. The method according to claim 8, wherein:
a gradient descent method is used to obtain the trained model parameters.

10. A time-value estimation system for sharing environment, comprising:
an information acquisition module configured to obtain time-values of a plurality of shared items and related information of the plurality of shared items from a sharing platform, wherein a time-value is a time duration for the shared item to be shared or traded;
a feature extraction module configured to extract a plurality of features of the plurality of shared items from the related information of the plurality of shared items, wherein the features include objective-level features related to a specific item and subjective-level features related to an owner of the specific item;
a time-value model generation module configured to obtain a time-value estimation function based on the time-values of the plurality of shared items and the plurality of features of the plurality of shared items; and
a time-value estimation module configured to estimate a time-value of an item in the sharing platform based on the plurality of features of the item and the time-value estimation function from the time-value model generation module.

11. The system according to claim 10, further comprising a buyer interface configured to:
receive a search query for obtaining a list of items on the sharing platform;
return a plurality of items satisfying conditions specified in the search query;
obtain, from the time-value estimation module, estimated time-values of the plurality of the returned items based on the time-value estimation function and the plurality of features of the returned items; and
display the plurality of the returned items in a sequence ordered based on the estimated time-values of the plurality of the returned items.

12. The system according to claim 10, further comprising a seller interface configured to:
receive a draft post of a to-be-shared item from a seller,
obtain, from the time-value estimation module, an estimated time-value of the to-be-shared item based on the time-value estimation function and the plurality of features of the to-be-shared item; and
present the estimated time-value of the to-be-shared item to the seller.

13. The system according to claim 12, wherein the seller interface is further configured to:
when presenting the estimated time-value of the to-be-shared item, provide two options to the seller including publishing the draft post and revising the draft post;
when the seller selects to publish the draft post, publish the draft post of the to-be-shared item on the sharing platform; and
when the seller selects to revise the draft post and submits a revised draft post, obtain, from the time-value estimation module, an estimated time-value of the to-be-shared item based on the revised draft post, and present the estimated time-value of the to-be-shared item to the seller.

14. The system according to claim 12, wherein the seller interface is further configured to provide revise suggestions to improve the estimated time-value of the to-be-shared item.

15. The system according to claim 10, wherein:
the subjective-level features of an item include at least one of: length of an item description, sentiment expressed in the item description, number of images, rating of the owner, and comments from previous buyers.

16. The system according to claim 10, wherein:
when the sharing platform is in a peer-to-peer accommodation domain, the objective-level features of an item include at least one of property type, number of bedrooms, number of bathrooms, amenities, and price;
when the sharing platform is in a peer-to-peer car sharing domain, the objective-level features of an item include at least one of car type, model, make, year, transmission, fuel consumption, and price; and
when the sharing platform is in a customer-to-customer transaction domain, the objective-level features of an item include at least one of product specifications, condition, and price:

17. The system according to claim 10, wherein:
provided that N shared items are denoted as {x⁽ⁱ⁾, y⁽ⁱ⁾}ᵢ₌₁^{N}, x⁽ⁱ⁾ denotes an i^{th} item represented by the plurality of features, y⁽ⁱ⁾ denotes the time-value of the i^{th} item, θ ∈ Rⁿ are model parameters,
the time-value estimation function is denoted as ƒ(x; θ)=exp(θ^{T}x); and
trained model parameters θ* are obtained by minimizing a squared loss function L(θ)=Σᵢ₌₁^{N}(y⁽ⁱ⁾(θ^{T}x⁽ⁱ⁾)−exp(θ^{T}x⁽ⁱ⁾)).

18. The system according to claim 17, wherein:
a gradient descent method is used to obtain the trained model parameters.
